(19) United States
(12) Patent Application Publication
(10) Pub. No.: US 2023/0419353 A1
(43) Pub. Date: Dec. 28, 2023

(54) Habit-Forming Software and Device Operating Method Therefor

(71) Applicant: A. Kyung Jang, Gunpo-si (KR)

(72) Inventor: A. Kyung Jang, Gunpo-si (KR)

(21) Appl. No.: 18/022,132

(22) PCT Filed: Aug. 18, 2021
(86) PCT No.: PCT/KR2021/010955

§ 371 Date: Feb. 17, 2023

(30) Foreign Application Priority Data
Aug. 19, 2020 (KR) 10-2020-0103585

(51) Int. Cl. G06Q 30/0207; G06F 21/32

(52) U.S. Cl. CPC G06Q 30/0209; G06F 21/32

(57) ABSTRACT

Habit-forming software is disclosed. According to one embodiment, during progress of a habit-forming project, habit-forming software activates an authentication button for performing an authentication action specified in the habit-forming project at a time specified in the habit-forming project and, when an input from a user who performs the authentication action is received through the authentication button, displays an avatar of the user, in which an increase of an ability point corresponding to a habit category, from among a plurality of ability points, is visually represented on the basis of the plurality of ability points and an achievement rate of the habit-forming project according to the authentication action. The user can be continuously motivated to form good habits through the changing avatar of the user by systematically ensuring that a sense of unity between the avatar and the user is maintained.

### TECHNICAL FIELD

One or more example embodiments relate to a habit-forming software and a device operating method therefor.

### BACKGROUND

Everyone wants to form good habits, but few people have actually succeeded in forming good habits. Therefore, there is a need for a product or service that can effectively help form good habits.

### DETAILED DESCRIPTION OF THE INVENTION

### Technical Solution

One of the most powerful elements that make up life is habit. Because everyone has a habit of leading their lives as they think, and habits are already patterned in the individual's brain and use up time, the material that constitutes life between individuals without being aware of it. The brain resists new behavior, and because of this resistance, it is not easy to make a new behavior a habit, so ‘force’ is necessary while the behavior becomes a habit.

When forming a habit, an individual must have ‘will power, environment creation, initiation, achievement, repetition, reward’ to change their lives. When this pattern is repeated over and over again, the part of the brain responsible for this behavior is activated and enlarged. Therefore, these behaviors must be repeated until appropriate neural circuits are constructed. The habit-forming service according to the embodiments provides ‘environment creation, sense of achievement, repetition, reward’ as an element that can help repetition from the outside. To this end, the embodiments may be serviced in the form of a habit-forming SNS avatar game based on brain science. The embodiments can function as a tool for improving habits by allowing them to form habits in the real world while interacting with others as avatars in a virtual space.

In accordance with an exemplary embodiment of the present disclosure, a method for operating a habit-forming software comprises: displaying a village interface including a plurality of places corresponding to a plurality of habit categories; receiving an input of a user requesting participation in a habit-forming project belonging to any one habit category selected through the village interface from among the plurality of habit categories; displaying a meeting interface including an avatar of the user and avatars of other users participating in the habit-forming project; while the habit-forming project is in progress, activating an authentication button for performing an authentication action specified in the habit-forming project at a time specified in the habit-forming project; receiving an input of the user performing the authentication action through the authentication button; and displaying the avatar of the user that visually expresses at least one of a plurality of ability points, wherein an ability point, from among the plurality of ability points, corresponding to the habit category is increased based on an achievement rate of the habit-forming project according to the authentication action.

The displaying of the avatar of the user may comprise providing usable items according to the ability point corresponding to the habit category, wherein as the ability point increases, more various items are provided; and applying an item, from among the items, selected by the user to the avatar of the user.

The usable items may comprise at least one of: a first type of item that transforms an appearance of the avatar itself; and a second type of item worn on the avatar.

An additional user authentication may be required when the selected item is an item of a specific level or higher, and the selected item may be applied to the avatar of the user when the additional user authentication succeeds.

A type and/or a number of habit-forming projects that the user can challenge may increase based on at least one of a level of the avatar and levels of the plurality of ability points.

The method for operating the habit-forming software may further comprise displaying an authentication photo of another user participating in the habit-forming project; and receiving an input of the user for inspecting an authentication action of the other user, wherein achievement rates of the users are determined according to results of the users participating in the habit-forming project inspecting each other's authentication action.

The method for operating the habit-forming software may further comprise displaying information that induces participation in the same habit-forming project after a predetermined period of time after the habit-forming project completes, wherein in-game currency for participating in the participation-induced habit-forming project are discounted or exempted, and rewards are paid when the participation-induced habit-forming project is achieved to a predetermined level or higher.

The plurality of ability points may include at least one of a health ability, an emotion ability, a relationship ability, a career ability, and a finance ability, and the plurality of habit categories may include at least one of the first category corresponding to the health ability, the second category corresponding to the emotion ability, the third category corresponding to the relationship ability, the fourth category corresponding to the career ability, and the fifth category corresponding to the finance ability.

The usable items may comprise at least one of: a third type of item that imparts a skill to the avatar; and a fourth type of item that imparts an emotional expression function to the avatar.

When an input of the user indicating that the authentication action of the other user is disqualified is received, a final inspection result of the authentication action of the other user may be determined through additional inspection by other users participating in the habit-forming project.

The method for operating the habit-forming software may further comprise activating buttons for sending friend requests to the avatars of the other users through the meeting interface when the habit-forming project completes.

The method for operating the habit-forming software may further comprise displaying an interface for modifying the avatar according to an increased ability point corresponding to the habit category when the habit-forming project completes; and displaying information for inducing re-participation in the same habit-forming project as the completed habit-forming project.

The method for operating the habit-forming software may further comprise at least one of: when an input of the user participating with an avatar of a friend user is received through the village interface or a place interface displaying detailed habit items or challenge steps corresponding to a place included in the village interface, displaying the detailed habit items or the challenge steps determined in consideration of the ability point of the avatar of the user and an ability point of the avatar of the friend user in a selectable form; and when an input of the user participating with the avatar of the friend user is received through the meeting interface, displaying a friend list determined in consideration of the detailed habit items and the challenge steps of the habit-forming project in a selectable form.

The method for operating the habit-forming software may further comprise conducting a survey on at least one of the plurality of habit categories to the user; and recommending at least one habit-forming project determined based on a result of the survey to the user.

### BRIEF DESCRIPTION OF THE DRAWINGS

FIG. 1 is a diagram illustrating the configuration of a system for providing a habit-forming service according to an exemplary embodiment.

FIG. 2 is an operational flowchart illustrating an operating method of habit-forming software according to an exemplary embodiment.

FIG. 3 illustrates a house interface according to an exemplary embodiment.

FIG. 4 illustrates a village interface according to an exemplary embodiment.

FIG. 5 illustrates a starting process of a habit-forming project in a meeting interface according to an exemplary embodiment.

FIG. 6 illustrates a progress process of a habit-forming project in a meeting interface according to an embodiment.

FIG. 7 illustrates a result of completion of a habit-forming project according to an exemplary embodiment.

FIG. 8 is a block diagram illustrating a configuration of a terminal for operating habit-forming software according to an exemplary embodiment.

### DETAILED DESCRIPTION OF EMBODIMENTS

Specific structural or functional descriptions disclosed herein are merely illustrative for the purpose of describing exemplary embodiments according to technical concepts, and the exemplary embodiments may be embodied in various other forms and are limited to the exemplary embodiments described herein.

Terms such as first or second may be used to describe various elements, but the terms are to be understood only for the purpose of distinguishing one element from another element. For example, a first element may be termed a second element, and similarly, a second element may also be termed a first element.

It will be understood that when an element is referred to as being “coupled” or “connected” to another element, the element may be directly coupled or connected to the other element, or intervening elements may also be present. In contrast, it will be understood that when an element is referred to as being “directly coupled” or “directly connected” to another element, there are not intervening elements present. Expressions describing the relationship between elements, for example, “between” and “directly between” or “neighboring to” and “directly adjacent to”, etc. should be interpreted similarly.

The singular forms, “a”, “an”, and “the” are intended to include the plural forms as well, unless the context clearly indicates otherwise. In the present specification, it should be further understood that the terms “includes” and/or “including” specify the presence of stated features, integers, steps, operations, elements, components, and/or groups thereof, but do not preclude the presence or addition of one or more other features, integers, steps, operations, elements, components, and/or groups thereof.

Unless otherwise defined, all terms used herein, including technical or scientific terms, have the same meaning as commonly understood by those of ordinary skill in the art. Terms, such as those defined in commonly used dictionaries, should be interpreted as having a meaning that is consistent with their meaning in the context of the related art and will not be interpreted in an idealized or overly formal sense unless expressly so defined herein.

The exemplary embodiments may be applied to various types of products, such as personal computers, laptop computers, tablet computers, smartphones, televisions, smart home appliances, intelligent cars, wearable devices, and the like.

Hereinafter, exemplary embodiments of the present disclosure will be described with reference to the drawings. Like reference numerals in each figure indicate like elements.

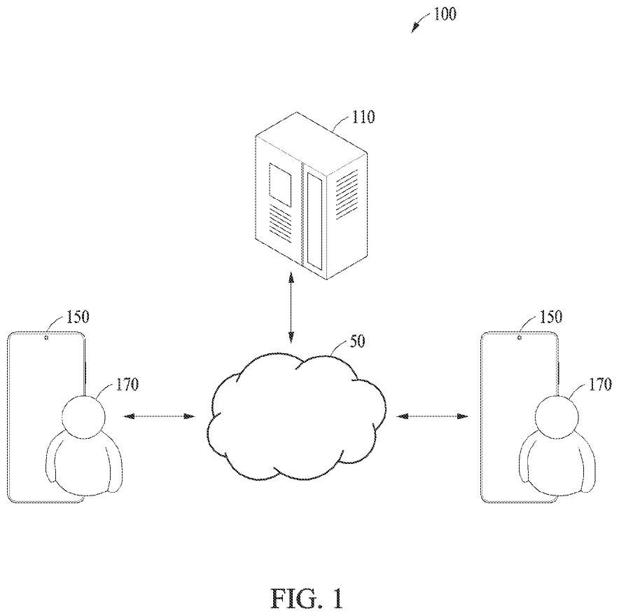

FIG. 1 is a diagram illustrating the configuration of a system for providing a habit-forming service according to an exemplary embodiment. Referring to FIG. 1, a system 100 according to an embodiment may include a server 110 and terminal(s) 150 of a user(s) 170. The server 110 and the terminal(s) 150 may be connected to each other through a communication network 50.

A habit-forming service according to an embodiment may be provided through software for habit formation (hereinafter referred to as ‘habit-forming software’). The habit-forming software is provided in the form of an avatar fostering game and may include elements of a social networking service.

The server 110 may be a server that provides a habit-forming service and may be interlocked with habit-forming software running on the terminal(s) 150 for a user interface (UI), function, operation or service. For example, the server 110 manages the account of the user(s) 170 using the habit-forming service, collects data from the terminal(s) 150, processes data necessary to provide the habit-forming service, and transmits the processing result to the terminal(s) 150. The habit-forming software may be distributed or provided to the terminal(s) 150 in various forms such as native apps, mobile web apps, web apps, and hybrid apps. Hereinafter, for convenience of description, embodiments in which the habit-forming software is operated by the terminal(s) 150 are described, but the habit-forming software may be operated by the server 110 in a cloud game manner.

The server 110 may include at least one processor that performs a process for the habit-forming service and may include a memory for storing data for the habit-forming service. Server 110 may be, for example, a single server computer or similar system, or may be multiple servers arranged in one or more server banks or other arrangements. Server 110 may be located in a single facility or may be a “cloud” of servers distributed among many different geographic locations.

The terminal(s) 150 may use the habit-forming service provided by the server 110 through habit-forming software. For example, the user(s) 170 may subscribe to a habit-forming service through habit-forming software installed on the terminal(s) 150, create a user account, and use the habit-forming service with the created user account.

The terminal(s) 150 may include a display, a memory, a processor, and a communication interface. The terminal(s) 150 may process a user interface or user interaction through a processor (e.g., the processor 810 of FIG. 8), or provide the processing result to the server 110.

The terminal(s) 150 may be, for example, as one of electronic devices such as a computer, a portable computer, a wireless phone, a mobile phone, a smart phone, a laptop computer, a personal digital assistant (PDA), a wearable device and a web tablet, it can encompass all computing devices capable of operating habit-forming software that works with the server 110.

Embodiments of the present invention propose services that help users form healthy habits. Configurations and/or steps necessary for the implementation of the present invention may be properly distributed and implemented at the server and client ends.

According to one embodiment, the embodiments of the present invention may be implemented in the form of an avatar game providing an intuitive user interface to form or improve habits of users. Embodiments of the present invention can continuously motivate users to form good habits through an avatar that maintains a sense of unity with the user. According to embodiments, it may be systematically ensured that a sense of unity between an avatar and a user is maintained. Due to this, the user can be continuously provided with motivation to form good habits through his or her changing avatar.

For example, embodiments of the present invention may generate an avatar based on an actual user upon user registration. To create an initial avatar, a user's face photo and/or a user's body shape photo may be used, and survey results received from users may also be used. The initial avatar may be created by modifying an external appearance in a direction of improving aesthetics while maintaining characteristic elements corresponding to the user.

As will be described in detail below, the initial avatar can be transformed through in-game currency (e.g., coins) that users are paid while successfully completing a habit-forming project. For example, an item worn by the initial avatar may be transformed or the basic skeleton of the initial avatar itself may be transformed. Also, the face or skin of the initial avatar may be transformed. At this time, only elements related to the habit-forming project can be transformed, so that the characteristics of the user, which are improved as habits are improved in the real world, can be intuitively expressed through the avatar in the virtual world.

Embodiments of the present invention may be distributed in the form of applications installed on smart devices. The application may provide a screen in the shape of a user's room. An avatar may be displayed in the user's room, and object(s) corresponding to the currently ongoing habit-forming project(s) may be displayed. In some cases, a list of ongoing habit-forming projects may be displayed through a text interface instead of a graphical interface. The graphic interface and the text interface can be switched according to the user's selection. In addition, an object for contacting other users participating in a habit-forming project in which the user participates may be displayed in the user's room. The corresponding object may provide functions such as a mobile phone in the virtual world. Of course, the actual phone numbers of other users are not disclosed, and the contact function may be provided using account information for subscribing to services according to embodiments of the present invention.

In the application, an object to go to the village of the virtual world is also displayed, and a village screen is provided according to the selection of the object. The village screen displays various places that act as gateways for each category of habit. According to the embodiment, a virtual village including corresponding places is implemented, and the user can freely move his or her avatar within the village. At this time, avatars of other users who are simultaneously accessing the corresponding village are displayed together, and a function of talking to each other through a speech bubble interface may also be provided.

More specifically, the village may include places for each category of habit, such as a gym, a movie theater, a school, a bookstore, a cafe, and a concierge. Each place provides a project to form and/or improve relevant habits. For example, upon entering a bookstore, a request for participation in a habit-forming project related to the bookstore (and/or books) may be applied through a clerk or bulletin board inside the bookstore.

The aforementioned village interface corresponds to one embodiment, and the village interface may be provided in a more simplified manner. For example, in the village interface, places for each habit category included in the village are displayed as selectable icons, and the user can enter the corresponding place by selecting the corresponding icon.

When a request for participation in a specific project is made, slots according to a pre-specified number of people are displayed, and the user's avatar may be displayed in one of the corresponding slots. Other slots may display avatars of other users who have applied for participation in the same project. When all empty slots are filled, the project can be started.

During the progress of the project, users must perform the specified authentication action at the time specified in the project. At this time, the designated authentication action may consist of action(s) that help to acquire a medically and/or scientifically appropriate habit. For example, if users are working on a “Get up at 6:00 AM” project, the designated authentication action may include uploading a photo of users' hands washing with cold water between 6:00 AM and 6:10 AM. In addition, the designated authentication action may include uploading a photo of a hand basking in the morning sun between 6:10 and 6:20 in the morning. The application can activate the authentication button only at the designated time, and the authentication action can be performed only through the camera shooting function through the authentication button. The camera view provided through the authentication button basically includes time information and may further include information related to a corresponding project.

Users can inspect each other's authentication actions. For example, a user participating in a project can check whether another user's authentication action is appropriate and then input the inspection result with [Appropriate: O, Confirmation required: Δ]. According to one embodiment, when a user uploads his/her own authentication photo, it can be induced to inspect the authentication photos of other users who have authenticated. It is not disclosed which user inspected the authentication action of a specific user, and the inspection result can be checked by the administrator. The authentication photo of the user who authenticated last on a specific date can be reviewed by the user who authenticated for the first time on the next date. In the case of the authentication photo of the user who authenticated last on the last date, it can be inspected by the administrator. Depending on the embodiment, the authentication photo of the user who last authenticated on the last day may be designed to be reviewed by another user who checks the achievement rate of the project, or by the first authenticator on the first day of a project started in the same type.

Users must deposit certain currency when participating in a project, and can be rewarded according to the achievement rate of the project. The project may be carried out for a predetermined period (e.g., 2 weeks), and the deposit currency and compensation may be variously determined according to the duration or difficulty of the project. Depending on the embodiment, each user may arbitrarily determine the amount of deposited currency, and in this case, compensation may be determined in proportion to the amount of deposited currency. The amount of deposited currency arbitrarily determined by the user is not disclosed to other users participating in the same project.

Compensation can be calculated differently according to the achievement rate of the project. For example, when 80% is achieved, the deposited currency is returned as it is, when 90% is achieved, the deposited currency is returned and a small amount of prize currency is paid, and when 100% is achieved, the deposited currency and the prize currency may be paid. Prize currency can be paid as in-game currency, used to decorate avatars, or used as deposit currency to participate in other projects.

In addition, the avatar's experience points may increase according to the achievement rate of the project. When the avatar's experience points rise (and/or the avatar levels up), the type or number of projects that can be challenged may increase. Alternatively, instead of separately applying experience points, a level system based on the avatar's ability points may be applied.

In addition, the avatar's ability level may increase according to the achievement rate of the project. Depending on the category of the project, the ability to increase can be set differently. When decorating an avatar, different usable items may be provided according to the current ability level. The user can apply available items to the avatar using in-game currency. Items can be divided into items that transform the appearance of the avatar itself and items that are worn on the avatar, and any type of item can directly or indirectly express the user's improved habits through the project. For example, when the appearance ability of the avatar is improved through the achievement of a project, the user may select from items related to the appearance, such as enlarging the avatar's eyes, adding eyelashes or double eyelids, or raising the nose.

Users can visually check the results achieved by participating in the project through their own avatars, and other users can see other user's avatars to gauge the lifestyle or diligence of the users.

Embodiments of the present invention may require an appropriate authentication procedure to the extent that if the avatar in the virtual world is charming, the identity of the user in the real world can be guaranteed. For example, in the case of an item having a certain level or higher, it may be designed so that it can be applied to an avatar only after additional user authentication is performed. For example, an item may be provided in several grades, and an item of the highest grade among them may be applicable only after additional user authentication. For example, as the abdominal muscle item, a low-grade obese abdominal muscle item, a medium-grade normal abdominal muscle item, and a highest-grade six-pack abdominal muscle item may be provided. Among them, the six-pack abs item can be designed so that it can be purchased only when the user authenticates a photo of his/her own abs, or it can be applied to an avatar.

Additional authentication may be requested in various forms, such as various physical fitness test records (e.g., ‘recording how many kilometers you run at a time’), awards, certifications, tests (e.g., mental health tests).

As mentioned above, when an avatar is created for the first time, an authentication photo for extracting a user's body type or facial features may be requested. Alternatively, when a specific ability level of the avatar reaches a specific level, an authentication photo of an actual user related to the corresponding ability level may be requested.

According to one embodiment, a dating place may be further included in the village screen. In this case, the user may determine a dating partner based on the sincerity, reliability, attractiveness, and interests of the avatar. In some cases, the habit-forming software may provide avatar information in the habit-forming service in conjunction with a third party application (e.g., a blind date app).

According to an embodiment, a function for confirming whether a habit corresponding to previously completed project is continuously maintained may be provided. After the user completes the project, information that induces participation in the same project after a certain period of time may be provided. In the case of a continuous project, users can participate without separately depositing in-game currency, and users can be encouraged to maintain their habits by receiving rewards when the project reaches a certain level or higher. Sustainable projects may also be designed in such a way that a predetermined number of users participate, all of whom can be selected as users who have previously completed the project.

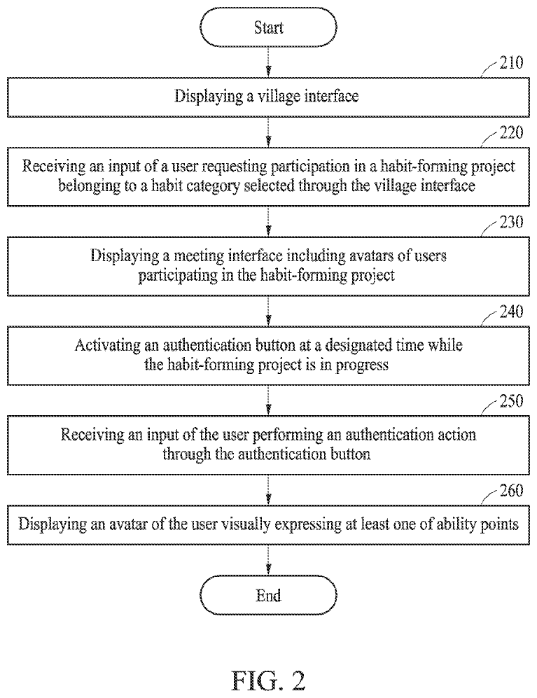

FIG. 2 is an operational flowchart illustrating an operating method of habit-forming software according to an exemplary embodiment. Referring to FIG. 2, the method of operating the habit-forming software includes steps 210 to 260.

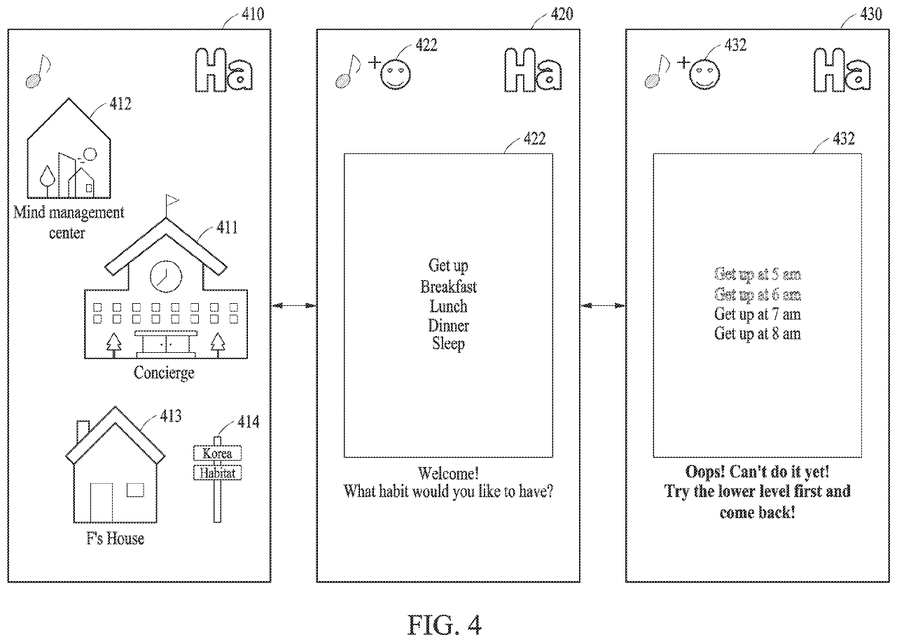

More specifically, the method of operation of the habit-forming software includes displaying a village interface (210). The village interface (e.g., the screen 410 of FIG. 4) may include places corresponding to a plurality of habit categories. The habit categories may be classified according to the abilities of the user's avatar, for example, a first category corresponding to health ability, a second category corresponding to emotion ability, a third category corresponding to relationship ability, a fourth category corresponding to career ability and a fifth category corresponding to finance ability. Places included in the village interface correspond to habit categories, and may include, for example, a concierge for the first category or a mind management center for the second category.

The method of operating the habit-forming software includes receiving an input of a user requesting participation in a habit-forming project belonging to a selected habit category through a village interface (step 220). The user may apply for participation in a habit-forming project of a habit category corresponding to the corresponding place by selecting one of various places displayed through the village interface.

According to an embodiment, the type and/or number of habit-forming projects to be challenged by the user may increase according to ability levels of the user's avatar. For example, the type and/or number of habit-forming projects that can be selected through the concierge may increase as the level of fitness ability increases. Alternatively, the type and/or number of habit-forming projects that the user can challenge may increase according to the level of the user's avatar. The level of the user's avatar may be increased by experience points given upon completion of a habit-forming project or may be determined by synthesizing the avatar's ability points.

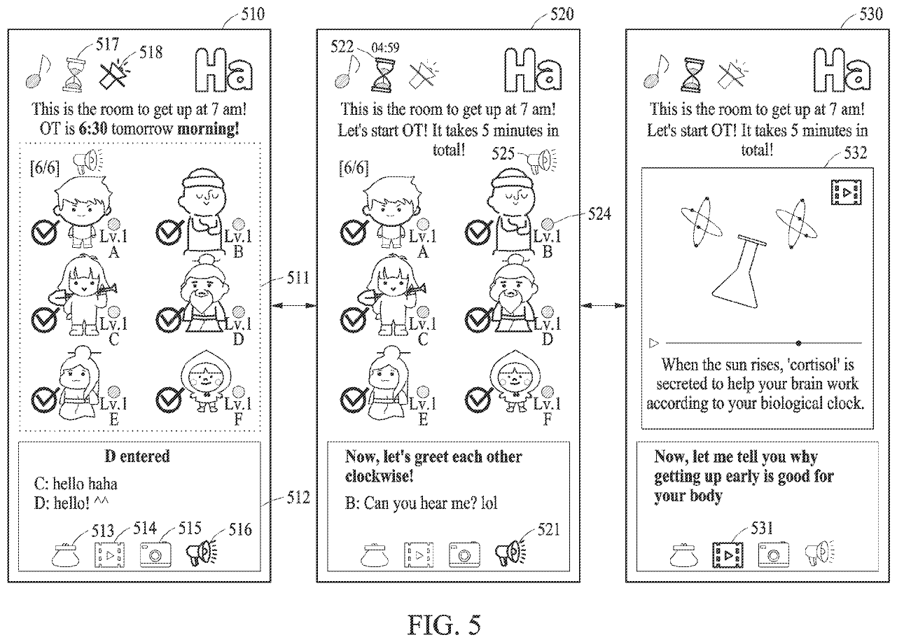

The method of operating the habit-forming software includes displaying a meeting interface (e.g., screen 510 of FIG. 5) including avatars of users participating in the habit-forming project (230). In addition to the user, other users may apply to participate in the habit-forming project of the same habit category, and in this case, the user's avatar and other users' avatars may be displayed on the meeting interface. When a predetermined number of users (e.g., 6) are gathered, a habit-forming project can be started.

The method of operating the habit-forming software includes activating an authentication button at a designated time while the habit-forming project is in progress (step 240). The habit-forming project (e.g., waking up at 7:00 am) may be carried out for a predetermined period (e.g., 2 weeks), and during that period, the authentication button for performing an authentication action (e.g., hand-washing photo) specified in the habit formation project may be activated only at a specified time (e.g., from 7 am to 7:10 am) in the habit-forming project.

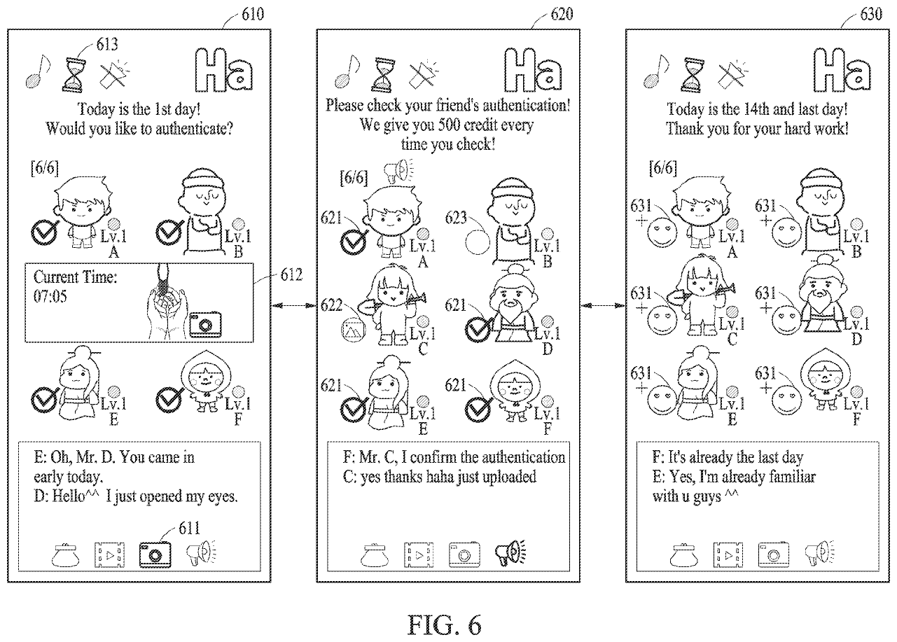

The method of operating the habit-forming software includes receiving an input of a user performing an authentication action through an authentication button (step 250). A achievement rate of the user who completes the habit-forming project may be determined according to a result of the user performing an authentication action during the period of the habit-forming project. Although described in detail below, according to an embodiment, users participating in the same habit-forming project can inspect each other's authentication actions. For example, the habit-forming software may display authentication photos of other users through a meeting interface (e.g., screen 620 of FIG. 6), and may receive an input from the user to inspect authentication actions of other users. In this case, the achievement rates of users who complete the corresponding habit-forming project may be determined according to the inspection results of authentication actions being inspected by other users participating in the same habit formation project.

The method of operating the habit-forming software includes displaying an avatar of a user visually representing at least one of the ability points (260). As described above, the user's avatar has a plurality of ability points, and among the plurality of ability points, the ability corresponding to the habit category of the completed habit-forming project may increase based on the achievement rate of the habit-forming project according to the user's authentication action. For example, the user's avatar may have ability points including at least one of health ability, emotion ability, relationship ability, career ability, and finance ability. If the user has completed the habit-forming project participated in through the concierge of the first category corresponding to the health ability, the health ability of the user's avatar may increase based on the achievement rate.

Step 250 includes providing usable items according to ability points corresponding to the habit category; and applying an item selected by the user from among the items to the user's avatar. The usable items are related to the ability points corresponding to the habit category, and may include at least one of a first type of item that transforms the appearance of the avatar itself, a second type of item worn on the avatar, a third type of item that imparts skills to the avatar, and a fourth type of item that imparts an emotional expression function to an avatar. For example, a first type of item related to the health ability may be an item that expresses the avatar's skin more clearly, and a second type of item related to the health ability may be a slim fit jeans item that the avatar can wear. A third type of item related to the health ability may be a skill item that enables an avatar to run. In addition, the fourth type of item related to emotion ability may be an emotional expression function item enabling an avatar to express a heart.

In the step of providing usable items, as the corresponding ability increases, various items may be provided. For example, the higher the health ability, the more diverse options within the same type of item may be provided. When the health ability is low, options are provided so that only rough skin items can be selected, and when the health ability is high, more options may be provided to select between rough skin items and clear skin items. Alternatively, as the health ability increases, options such as normal fit jeans, slim fit jeans, and skinny fit jeans may increase, and options such as running speed or running motion may increase.

Alternatively, various types of items may be provided as the health ability increases. When the health ability is low, only the first type of item is provided, and when the health ability is high, the second type of item or the third type of item may be selectively provided together.

According to an embodiment, when the selected item is an item of a specific grade or higher, additional user authentication may be required. For example, when an item representing six pack abs is selected for an avatar by a user, and the corresponding item is set to a predetermined level or higher, additional authentication (e.g., a photo of the user's actual abs) may be required to authenticate. The corresponding item may be applied to the user's avatar as additional user authentication succeeds.

According to one embodiment, the operation method of the habit-forming software may further include displaying information inducing participation in the same habit-forming project after a certain period of time after the habit-forming project is completed. In this case, in-game currency for participating in the habit-forming project inducing participation are discounted or exempted, and rewards can be paid when the habit-forming project inducing participation is achieved to a certain level or higher.

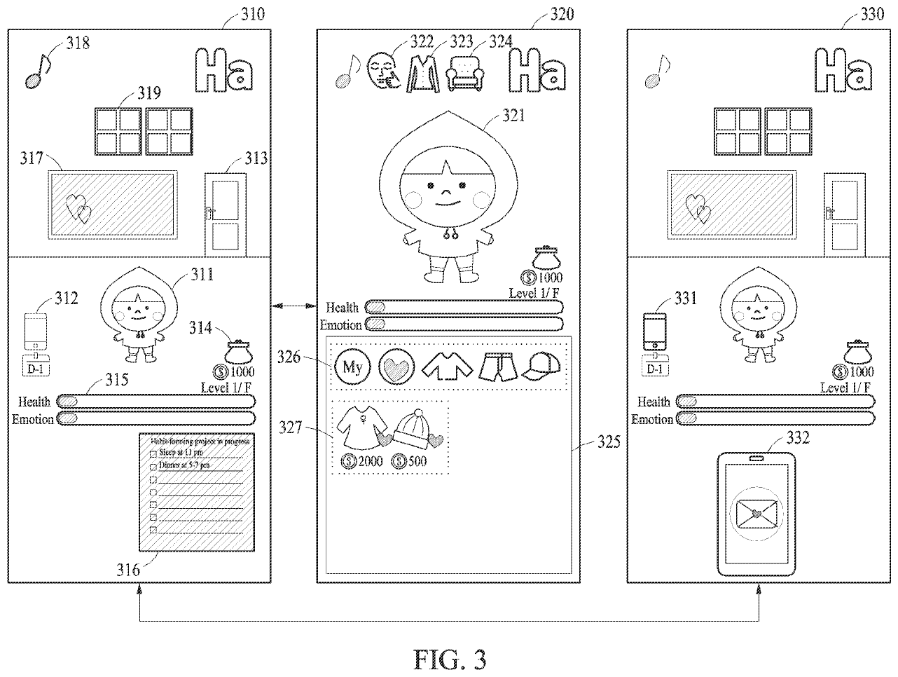

FIG. 3 is a diagram illustrating a house interface according to an exemplary embodiment. Referring to FIG. 3, the habit-forming software may display a house interface 310 after a user creates an account and logs in.

A user's avatar 311 may be displayed on the house interface 310. In addition, the house interface 310 includes a status view 315 displaying the avatar's ability points, a wallet object 314, an object 316 displaying a list of currently ongoing habit-forming projects, and an object 318 for controlling background music, an object 312 for contacting an avatar of a friend relationship in the habit-forming service, an object 313 for moving to a village interface, and the like may be further displayed. In addition, various furniture objects for decorating the house, such as a blackboard object 317 or a window object 319 for committing a goal, may be further displayed on the house interface 310. Although not shown in the drawing, various objects that help the user form habits in the real world, such as objects on which already achieved goals can be hung, may be displayed on the house interface 310.

When the habit-forming project displayed in the object 316 is selected, the meeting interface 510 of FIG. 5 may be displayed. Depending on the embodiment, the object 316 may display a habit-forming project recommended to the user as well as a habit-forming project currently in progress. The recommended project may be displayed through a separate pop-up window instead of the object 316.

The avatar status view 315 may display the avatar's name, the avatar's ability points, and/or the avatar's level. Although not shown in the figure, a separate level may be assigned to each ability of the avatar, and the ability point accumulated at the current ability level may be displayed in a graphic form such as a progressive bar.

The level of the avatar may be determined through statistical processing (e.g., average, weighted average, etc.) of ability levels, or may increase through a separate experience point. The level of the avatar may be used to rank among avatars of the habit-forming service or avatars of friend relationships.

According to one embodiment, the habit-forming software may conduct a survey to investigate the user's biological characteristics and/or psychological characteristics when the user creates an account in the habit-forming service. According to the result of the survey, the initially created avatar's ability points may be determined, and a habit-forming project(s) suitable for the user may be recommended. In addition, the avatar's initial stats may be set according to the survey results, and in order to set stats above a specific value or level, additional authentication procedures (for example, a photo of a user's face or body in the real world, professional certifications, or an advanced survey etc.) may be required.

Depending on the embodiment, a function for the user to set the ability of the avatar within a predetermined range may be provided. The initially set ability level and the ability point increased through the habit-forming project may be displayed to be distinguished from each other.

In addition, an avatar may be created by reflecting the user's appearance or physique according to a survey result or an additional authentication procedure. For example, the avatar's gender may be selected, and the avatar's physique may be determined based on a user's photo. A plurality of pre-arranged characters may be provided as selectable avatar candidates, and various appearance sets may be provided so that each character may be initially set and transformed into an appearance corresponding to the user's biological/psychological characteristics.

Even after an account is created, the habit-forming software may conduct additional surveys at predetermined intervals or at times according to the habit-forming service's operation policy. Depending on the result of the additional survey, the avatar's ability points may be adjusted, or a habit-forming project (s) suitable for the user may be recommended.

The habit-forming software may provide the user with the ability to freely decorate the house interface 310. For example, after completing a habit-forming project of a specific level, the user places a certificate of completion of the project on the house interface 310 in the form of a frame or bulletin board, or purchases items (e.g., furniture, etc.) using in-game currency obtained by completing the project and places the items in the house interface 310.

According to one embodiment, the user may acquire in-game currency through payment, but the habit-forming software can make a distinction between items that can be purchased with in-game currency obtained through payment and items that can be obtained by completing a habit-forming project. In other words, since there are items that can only be obtained by completing a habit-forming project, the habit-forming service can provide a sense of achievement in which habit improvement in the real world is expressed through an avatar.

A user's avatar may have various ability points. For example, referring to Table 1, an avatar may have at least one of health ability, emotion ability, relationship ability, career ability, and finance ability. As described above, the avatar's ability points may be displayed on the status view 315 of the house interface 310. The ability points in Table 1 are exemplary, and in addition to the ability points listed in Table 1, various abilities such as physical ability, intelligence ability, reputation ability, interest (joy) ability, or appearance ability may be considered.

TABLE 1

| | |
|---|---|
| Habit reflection model | Decisions made taking into |
| (Ability point) | account user's deficiencies |
| Health ability (Charm | The ability to live a healthy and active life (promote a |
| ability) | healthy lifespan) and attract a large influx of good people |
| Emotion ability | The ability to maintain one's own health |
| | and work with others smoothly |
| Relationship ability | The ability to recognize good people and have good |
| | relationships with them to help energize and increase |
| | capital inflows. |
| Career ability (success | The ability to accurately identify what is helpful to |
| ability) | oneself, what one likes, and what aptitudes are, and fill |
| | one's life with them |
| Finance ability | The ability to manage, maintain and increase the |
| | currency that flow into oneself based on accurate |
| | knowledge of capitalism |

When the avatar 311 on the house interface 310 is selected, the habit-forming software may display the avatar editing interface 320. The avatar modification interface 320 may include an avatar 321 and an item view 325. The avatar modification interface 320 may further include type control objects 322, 323, and 324 to display selectable items by type in the item view 325. For example, if the first type control object 322 is selected, the habit-forming software may display the first type of items that modify the appearance of the avatar itself in the item view 325. When the second type control object 323 is selected, the habit-forming software may display the second type of items worn on the avatar in the item view 325. When the third type control object 324 is selected, the habit-forming software may display furniture items decorating the house interface 310 in the item view 325.

The item view 325 may display tab control objects 326 and items 327 that classify types of items according to type control objects 322, 323, and 324. For example, as the second type control object 323 and the favorites tab are selected, the item view 325 of the avatar modification interface 320 may display items 327 favorited by the user among the second type of items worn on the avatar. In some cases, in-game currency may be required to reflect the items 327 to the avatar 321.

According to the habit-forming service according to an embodiment, as the actual health and capacity of users in the real world are improved while completing habit-forming projects, the ability level of the avatar may increase. The increased abilities of the avatars can be expressed in various forms as shown in Table 2. The items in Table 2 are exemplary, and in addition to the items listed in Table 2, various expression methods such as ‘changing into a more intelligent person by reading a book’ may be applied.

TABLE 2
Example reflected in avatar

| | |
|---|---|
| Health ability (Charm | Depending on the level the user achieves, the adjustable |
| ability) | range of the item changes |
| | Users can adjust the avatar's facial features such as skin |
| | color, eye size, lip color, facial sagging, and wrinkles |
| | Users can adjust the shape and thickness of arms/legs |
| | and torso |
| Emotion ability | Depending on the level the user achieves, the adjustable |
| | range of the item changes |
| | Avatar's facial expressions have been changed to |
| | expressions that signify each stage of the ‘consciousness |
| | revolution’ (emotion level can be quantified by ‘self- |
| | esteem’ level, etc.) |
| | Allows users to acquire several items used to control |
| | their emotions |
| | * Meditation videos, meditation music, related books (if |
| | users collect several pieces, users can get a real book), if |
| | users collect 10 pieces, users can get a coupon to consult |
| | with an expert (time/expert level varies), users can listen |
| | to related lectures such as psychology lectures |
| | * Items such as music, paintings, and nature can be |
| | placed in the avatar's house |
| Relationship ability | Depending on the level the user achieves, the adjustable |
| | range of the item changes |
| | Adjusted the number of other avatars that can visit the |
| | avatar's house (1-100, etc.) |
| | Avatars can now host various gatherings (social |
| | influence) |
| | Avatars acquire various items related to ‘relationships’ |
| | (pretty stationery, stickers, video letters, photo albums, |
| | gifts, etc.) |
| Career ability (Success | Depending on the level the user achieves, the adjustable |
| ability) | range of the item changes |
| | ‘Badge authentication’ available on the avatar screen |
| | Increased self-development tools that avatars can place |
| | at home (books (ebooks), self-development videos, |
| | exercise equipment (affiliated with actual exercise |
| | facilities, ‘one-time experience’ appears when an item is |
| | pressed once a day, etc.) possible), etc. −> users can |
| | actually own it later in the rental, and users can share it |
| | with friends avatars) |
| | Various fields of expertise (relevant tasks such as |
| | CSAT, law school, protocol, etc. can be carried out one |
| | by one by receiving from experts) |
| | Successful people can act as mentors later and receive |
| | coins from the avatars they use. |
| Finance ability | Depending on the level the user achieves, the adjustable |
| | range of the item changes |
| | ‘Badge authentication’ available on the avatar screen |
| | ‘Special Coin’ paid to avatars who fulfill |
| | Only avatars with special coins can participate in |
| | lectures held by economic figures on a first-come, first- |
| | served basis. |

* Induce dopamine secretion by providing various and unpredictable items and event pop-ups
* Cell phone lock down from a pre-determined time (e.g., 1:00 AM)

When a contact is received from an avatar of a friend relationship in the habit-forming service, the object 331 of the house interface 330 may visually display the fact that a new contact has been received. For example, when a new message is received from an avatar of a friend relationship, a heart-shaped indicator may be displayed on the object 331. When the object 331 is selected in the house interface 330, the habit-forming software may display a corresponding message through the message display object 332.

FIG. 4 is a diagram illustrating a village interface according to an exemplary embodiment. Referring to FIG. 4, the village interface 410 may include places (e.g., buildings, natural objects, sculptures, etc.) 411 and 412 corresponding to various habit categories. For example, a place of the first category corresponding to health ability may be expressed as the concierge 411, and a place of the second category corresponding to emotion ability may be expressed as the mind management center 412.

Although not shown in the drawings, a place of the first category corresponding to health ability may be expressed as places related to health promotion, such as gyms, in addition to concierges. A place of the second category corresponding to emotional abilities may be expressed as places related to understanding emotions, such as meditation centers, in addition to the mind management center. In addition, a place of the third category corresponding to relationship ability are expressed as places related to relationship formation, such as schools, community centers, and cafes. A place of the fourth category corresponding to career ability are expressed as places related to jobs or careers such as companies, courts, and hospitals. A place of the fifth category corresponding to finance ability may be expressed as a place related to finance or assets, such as a bank, a securities company, and real estate. Places in the village interface 410 may provide a function for gathering other avatars who will together achieve a habit of a category associated with the place.

In addition, the village interface 410 may further include a place where other users' habituation tips or reviews can be viewed, and this place may be expressed as a school or the like. From there, users can recommend habit-forming projects, share tips, and suggest new habit-forming projects. Depending on the embodiment, when the avatar reaches a certain level, a function of creating a new habit-forming project may be provided.

Depending on the embodiment, the village interface 410 may further include a dating place where the avatar arranges a meeting with other avatars. In a dating place, a blind meeting with another avatar may be arranged based on the sincerity and/or reliability of the avatar. Through the places of the village interface 410, advertisements of habit categories corresponding to the corresponding places and/or advertisements corresponding to the purpose of the corresponding places may be exposed.

The village interface 410 may further include a house 413 of the user's avatar, and when the house 413 of the user's avatar is selected, the house interface 310 of FIG. 3 may be displayed. In addition, the village interface 410 may further include an object 414 indicating a region (e.g., country) to which the corresponding village belongs, and through selection of the corresponding object 414 or other designated interactions, village interfaces in other regions (e.g., other countries, etc.) may be displayed.

When a place is selected by a user in the village interface 410, the habit-forming software may display an item selection interface 420 including detailed habit items corresponding to the selected place. The detailed habit items may include detailed habit items (or routine items) belonging to the habit category of the corresponding place.

Although not shown, the habit category may be subdivided (and/or classified) into subcategories. For example, the first category corresponding to the health ability of the concierge 411 may be subdivided into a lifestyle category and an exercise category. Subcategories may be provided by being classified within a selected place, and may be classified, for example, to different floors in a building or to different NPCs in a building. When a subcategory is selected, the habit-forming software may display an item selection interface 420 including detailed habit items belonging to the selected subcategory.

According to an embodiment, habit items (or routine items) selectable in the item selection interface 420 may be determined differently according to the ability level of the user's avatar. For example, when the concierge 411 is selected, selectable habit items (or routine items) may be determined according to the health ability corresponding to the concierge 411 among the avatar's ability points. Of course, according to circumstances, selectable habit items (or routine items) may be determined by a combination of health ability and other abilities. In addition, selectable habit items (or routine items) may be determined according to the avatar's ability level or the level of the avatar rather than the avatar's ability points.

For example, if the health ability level is 1, it is possible to challenge the habit items of ‘get up early and go to bed early’ or ‘eat at regular times’, and as the health ability level rises, it may be possible to challenge more difficult habit items such as ‘exercise for strength’, etc. By improving habits step by step, users can feel a continuous sense of achievement, establish healthy habits in real life, and can be provided with a user experience in which the avatar and the self in the real world develop mentally and physically together.

When an item is selected by the user in the item selection interface 420, the habit-forming software may display a step selection interface 430 including challenge steps corresponding to the selected item. As in the item selection interface 420, the level selection interface 430 may also determine selectable challenge levels according to the avatar's ability points or ability level, or the level of the avatar.

Table 3 is a table illustrating interlocking abilities and challengeable items for each place included in the village interface 410. Table 3 corresponds only to exemplary matters, and embodiments may be modified so that various venue-interaction ability-challenge items are matched with each other.

TABLE 3

| | interlocking | |
|---|---|---|
| Place | ability | challengeable item |
| Gym | physical | 30 minutes aerobic exercise per day |
| (work out) | ability | 1 home workout per day |
| | appearance | 1 hour of strength training per day |
| | ability | Yoga twice a week |
| | | Pilates twice a week |
| | | Ballet twice a week |
| | | basketball once a week |
| | | tennis once a week |
| Concierge | physical | go to bed early |
| (lifestyle) | ability | get up early |
| | | Take a foot bath |
| | | take a bath |
| Bookstore | intelligence | Read 1 book per week |
| (reading) | ability | Write a book review per week |
| | reputation | |
| | ability | |
| | interest | |
| | ability | |
| Mountain | physical | Riding a bike for 20 minutes a day |
| (outdoor | ability | Hiking once a week |
| activities) | interest | |
| | ability | |
| Movie | intelligence | Watch an independent movie once a week |
| theater | ability | Write a film critique |
| (cultural | interest | Enjoy watching movies |
| life) | ability | Watch 1 concert |
| | reputation | Visit 1 exhibition |
| | ability | |
| Pet shop | interest | Going for a walk with your pet |
| (companion | ability | Bring pet snacks |
| animal) | reputation | Give your pet a bath |
| | ability | Pet vaccination |
| Restaurant/ | physical | Eat on time |
| Cafe | ability | Eat 2 meals a day (reduce) |
| (eating | appearance | Eat 6 meals a day (increased) |
| habits) | ability | Drink 2 liters of water per day |
| | | Eat 1 salad per day |
| | | Eat 1 piece of fruit per day |
| | | Drink tea once a day |
| | | Drink a healthy drink once a day |
| | | intermittent fasting |
| Beauty shop | appearance | Daily hair treatment |
| (appearance) | ability | 1 pack per day |
| | | Daily hair brushing |
| | | Remove makeup and sleep |
| Religious | reputation | Write a gratitude journal every day |
| facilities | ability | Meditate daily |
| (religion) | | Attend a religious meeting once a week |

When a challenge step is selected in the step selection interface 430, a screen (not shown) for depositing predetermined currency to participate in the habit-forming project may be displayed. The deposit cost is different for each user, and mutual deposit costs can be kept private among users participating in the same habit-forming project.

The deposit cost may be refunded according to the achievement rate or performance rate of the habit-forming project of the corresponding user after the habit-forming project is completed. For example, when the target of 80% is achieved, the deposit cost may be refunded as it is, and when the target of 100% is achieved, the deposit cost may be refunded and additional prize currency may be paid. In addition, when the 90% goal is achieved, the deposit fee is refunded and a small amount of prize currency may be paid. If the target is achieved with less than 80%, the deposit fee may be deducted, and the deducted amount may be paid as prize currency to other users.

According to an embodiment, a habit-forming project related to ‘habits that have had the most positive impact on one's life’ may be established by a socially successful person (e.g., an influencer). In this case, the opened habit-forming project may be classified and provided as a sub-category of influencer within the most relevant habit category among habit categories, or be classified and provided as a separate place (e.g., broadcasting station) in the village interface 410. In order to participate in such a habit-forming project, a separate participation cost may be added, and the revenue due to the added participation cost may be shared between the creator and the operator of the habit-forming service at a pre-agreed ratio.

According to an embodiment, a function for communicating and socializing with each other while the user's avatar and the other users' avatars move around in the village interface 410 may be provided. The habit-forming software may support chatting between avatars located close to each other within the village interface 410 and may provide a function of participating in a habit-forming project with like-minded avatars. In addition, the habit-forming software may expose avatars that have similar inclinations or have similar ongoing habit-forming projects to each other. Habit-forming software can provide a function to report a person who engages in strange conversations with an evidence photo, and the account of a user who has received a predetermined number of reports (e.g., 5 times) is suspended for a certain period of time, A user's account that has accumulated a number of (e.g., three) suspensions may be permanently suspended.

According to one embodiment, the item selection interface 420 may display a friend object 422. Once the friend object 422 is selected, the habit-forming software may provide a list of avatars that are friends on the habit-forming service so that the avatars may be selected with whom they wish to participate in the habit-forming project. The number of avatars that can participate together in the habit-forming project may be limited to a predetermined number (e.g., a total of two including the user's own avatar and one friend's avatar).

The habit-forming software sends an invitation message to the selected friend avatar, and the friend avatar can accept or reject the invitation message after checking the invitation message through the objects 331 and 322 of the house interface 310.

When a friend avatar is selected through the friend object 422, the habit-forming software may consider the user's avatar's ability points and/or ability level and the friend's avatar's ability points and/or ability level, and display habit items (or routine items) selectable from the item selection interface 420. For example, only habit items (or routine items) in which the user avatar and friend avatars can participate together may be displayed on the item selection interface 420.

When an item that can be participated in with a friend avatar is selected, the habit-forming software may consider the user's avatar's ability points and/or ability level and the friend's avatar's ability points and/or ability level together, and display a challenge step selectable from the step selection interface 430 For example, only steps that can be challenged together by the user's avatar and the friend's avatar may be displayed on the step selection interface 430.

According to one embodiment, the step selection interface 430 may display a friend object 432. When the friend object 432 is selected, the habit-forming software may provide a list of avatars that are friends on the habit-forming service so that a friend avatar may be selected with whom it wishes to participate together in a habit-forming project. At this time, the habit-forming software may display a friend list so that only friend avatars having ability points and/or ability levels capable of performing the habit item (or routine item) selected in the item selection interface 420 can be selected.

The habit-forming software sends an invitation message to the selected friend avatar, and the friend avatar can accept or reject the invitation message after checking the invitation message through the objects 331 and 322 of the house interface 310.

When a friend avatar is selected through the friend object 422, the habit-forming software may consider the ability points and/or ability level of the user's avatar and the friend avatar's ability points and/or ability level, and display challenge steps selectable from the step selection interface 430. For example, only steps that can be challenged by the user's avatar and the friend's avatar together may be displayed on the step selection interface 430.

Meanwhile, the UI of the item selection interface 420 and the UI of the step selection interface 430 are merely examples, and after a place corresponding to the habit category is selected in the village interface 410, the habit item (or routine item) and/or a UI for selecting a challenge step may be modified in various ways.

FIG. 5 is a diagram illustrating a starting process of a habit-forming project in a meeting interface according to an embodiment. Referring to FIG. 5, the meeting interface 510 may include a participant view 511 and a chatting view 512. In addition, the meeting interface 510 may further include a wallet object 513, an effect-viewing object 514, an authentication object 515, a speaking object 516, and a timer object 517.

If a predetermined number of seats (e.g., 6 people) are reserved for the habit-forming project, and avatars participate in the corresponding seats (e.g., in order of first-come, first-served basis), the habit-forming project can be started. Avatars participating in the habit-forming project may be displayed in the participant view 511. If there are avatars who participated together, the fact that they participated together can be displayed to other users. Although not shown in the drawings, the participant view 511 can be formed in the shape of a ship or a spaceship, and when avatars board all seats, the progress of the habit-forming project can be expressed in various ways, such as being shown as a ship or spaceship departing.

A chatting conversation between users is displayed in the chatting view 512, and a voice conversation may proceed by selecting the speaking object 516. Whether or not the speaking object 516 is selected may be displayed through the speech sound object 518. The timer object 517 may be an object for displaying various time limits necessary for the progress of the habit-forming project. The effect-viewing object 514 may be an object for showing the effect of a participating habit-forming project through multimedia. The authentication object 515 is a selectable object for performing an authentication action specified in the habit-forming project, and may be activated only at a predetermined time while the habit-forming project is in progress.

Referring to the meeting interface 520, as the habit-forming project starts, the habit-forming software provides a time for users to greet each other by voice for a predetermined time (e.g., 5 minutes), so that they can bond with others (rapport) and lead them to better keep their promises with others. Users may select the speaking object 521 to conduct a voice conversation, and the time limit may be counted down through the timer object 522.

The avatar view may include an object 524 for reporting participating avatars. A warning object 525 may be marked on the avatar for which the report has been received, and a user of the corresponding avatar may be warned.

Referring to the meeting interface 530, a video view 532 playing multimedia content related to a habit-forming project may be displayed. The video view 532 may be played automatically after the time for greeting each other ends, and may be played in response to selecting the effect-viewing object 531 in some cases. For example, a video introducing the positive impact of the corresponding habit-forming project on the human body, or a video explaining that users must create a suitable ‘environment’ to form a habit when performing a habit-forming project, or a video introducing step-by-step methods that help to implement the action scientifically for each mission to be achieved in the habit-forming project can be played.

The duration of a habit-forming project can be defined as a minimum amount of time to build confidence before incorporating a habit (e.g., 2 weeks). During the execution period, users can use the mobile phone object 312 of the house interface 310 to contact team members participating in the same habit-forming project. When the execution period ends, users may no longer be able to contact the ex-team members, but users may continue to contact team members who made friends during the execution period even after the execution period ends. As will be described below, when the performance period ends, time for team members to make friends may be granted for a certain period of time (e.g., the last day).

Habit-forming software may provide a function of blocking contact with a specific team member. Also, when a message is transmitted within the habit-forming service, the user's smartphone may notify the habit-forming service via a push message, thereby improving the habit-forming service access rate.

Although not shown in the figure, the avatar view 511 of the meeting interface 510 may display an empty seat where no avatar has participated yet. If a specific avatar participates in the meeting interface 510 in a state of requesting other avatars to participate together, a seat for the invited avatar may be guaranteed for a predetermined time limit (e.g., 1 hour). The avatar view 511 of the meeting interface 510 may display the fact that there is an avatar invited to the corresponding seat, and may also display how much time left to respond to the invitation. If the invited avatar checks and accepts the invitation message within the time limit, the corresponding seat of the avatar view 511 may be filled with the invited avatar. If the invited avatar does not check the invitation message until the time limit has elapsed, or if the invited avatar confirms the invitation message and rejects it even before the time limit has elapsed, the corresponding seat in the avatar view 511 is converted to an empty seat. This will allow other avatars to participate.

According to one embodiment, the habit-forming software may provide a function of inviting friend avatars after participating in the habit-forming project. For example, users may use a function of inviting friend avatars by selecting an empty seat in the avatar view 511.

After participating in the habit-forming project, if an input for inviting avatars of friend relationships is received, the habit-forming software may display a list of friend avatars capable of participating in the corresponding habit-forming project. When a friend avatar is selected from the displayed list, the habit-forming software may send an invitation message to the selected friend avatar and guarantee the corresponding vacant seat for a limited time.

FIG. 6 is a diagram illustrating a progress process of a habit-forming project in a meeting interface according to an exemplary embodiment. Referring to the meeting interface 610 of FIG. 6, the habit-forming software may selectively activate an authentication object 611 at a designated time in a habit-forming project. For example, if the habit-forming project corresponds to ‘get up at 7:00 am’ for 2 weeks, the habit-forming software activates the authentication object 611 for 10 minutes from 7:00 in the morning, and the authentication object 611 after the corresponding time (611) can be disabled. The habit-forming software may display the remaining time to perform the authentication action through the timer object 613.

According to an embodiment, as a first step of a habit-forming project, an act of pre-authentication that an environment capable of helping the achievement of a target habit is created by taking a picture may be required. For example, if the habit-forming project a user participated in is ‘get up at 6:00 am and walk outside’, the pre-authentication action may include to shoot a scene where the user set the alarm clock to get up the next day or a scene where the user bring clothes to wear the next day in advance. action. The time at which the pre-authentication action can be performed (for example, until midnight on the previous day of OT (orientation)) may be determined in advance and displayed through the timer object 613, and the authentication object 611 may be activated until the corresponding time. The pre-authentication action may be requested once when the habit-forming project starts, but may be requested periodically or randomly during the progress of the habit-forming project depending on circumstances and settings.

When the authenticate object 611 is selected, the habit-forming software may display a camera preview 612. A current time may be displayed on the camera preview 612 and a photograph may be taken together with an authentication action. Here, the authentication action is a predetermined act to certify that the habit-forming project has been performed, for example, ‘taking a scene of washing one's hands in a sink’ or ‘taking a picture of one's hands facing the morning sun through a window’, etc. Authentication actions may be structured in a way that positively affects the human body in relation to the corresponding habit-forming project. For example, ‘washing your hands with cold water’ or ‘getting the sun in the morning’ are ways to help the human body switch from a sleep state to an awake state, and the habit-forming project of ‘get up at 7:00 in the morning’ is certified. It can correspond to a method that helps to naturally embody the habit while doing it.

The meeting interface 620 may display whether or not users participating in the habit-forming project have performed an authentication action and whether each user's authentication action has been inspected by another user. For example, the meeting interface 620 may display authentication confirmation objects 621, 622, and 623 near the avatars.

If the user of a specific avatar (e.g., B) has not yet performed an authentication action, the habit-forming software may display the first type authentication check object 623 on the avatar. The authentication confirmation object 623 of the first form may be selected by another user, and in this case, the habit-forming software may display an interface for contacting the corresponding avatar (notification transmission, message transmission, voice call request, etc.).

When a user of a specific avatar (e.g., C) performs an authentication action, the habit-forming software may display a second type of authentication confirmation object 622 on the corresponding avatar. The authentication confirmation object 622 of the second type may be selected by another user, and in this case, a result (e.g., a photo) according to the authentication action may be displayed to the corresponding other user. The habit-forming software may provide inspection buttons (e.g., O button and X button) while displaying the result of the authentication action. When an authentication action is inspected by a predetermined number (e.g., one) of other users, the habit-forming software may display a third type of authentication confirmation object 621 to the corresponding avatar. As will be described below, in order to prevent fraudulent inspection, the habit-forming program may not allow inspection of each other's authentication between friends who participate together.

If another user's authentication action is inspected as disqualifying, an additional inspection opportunity may be granted to a predetermined number (e.g., two) of other users. In this case, the eligibility or ineligibility of the authentication action under examination may be finally determined by combining the inspection result of the first user and the inspection results of additional users (e.g., majority vote). Similarly, in order to prevent fraudulent inspection, the habit-forming program may not grant an additional inspection opportunity between friends who participate together. In addition, a reporting function for an inaccurate authentication shot may be provided.

Habit-forming software may provide rewards in response to the act of inspecting another user's authentication action. Rewards may include in-game currency and the like.

If a specific user fails to perform an authentication action within the specified time, or if he or she performs an authentication action within the specified time but is judged ineligible by other users, the user is recorded as having failed to perform an action for habit-forming on that date, and the user's achievement rate of the habit-forming project may be lowered.

Habit-forming software can work in conjunction with IoT devices to trigger automatic notifications from IoT devices at designated times in the habit-forming project. For example, it can be set to sound a notification to eat at a set meal time from a smart refrigerator or play meditation music from a smart speaker at a set bedtime.

When a specific user has performed an authentication action within a specified time, but has not received inspection from other users, a notification message may be transmitted to other users. The inspection of the authentication action may proceed even after the time specified for the authentication action, and the notification message may be transmitted to a randomly selected user among other users or may be transmitted to a user who has not performed the inspection action on the corresponding date.

If authentication is successful as a result of another user's inspection, the habit-forming software may sensibly display an authentication success screen so that dopamine of a rewarded feeling is strongly released. For example, the authentication success screen may be configured to visually express contents praising the user. On the other hand, if authentication fails as a result of another user's inspection, the habit-forming software may provide feedback to the user of the reason for authentication failure and what can be learned from it.

When the habit-forming project is completed, the habit-forming software may display an object 631 capable of making friends with other avatars on the meeting interface 630. The habit-forming software may display an object 631 capable of making friends with other avatars for a predetermined time (e.g., a day when a habit-forming project is completed), and then terminate the meeting interface 630.

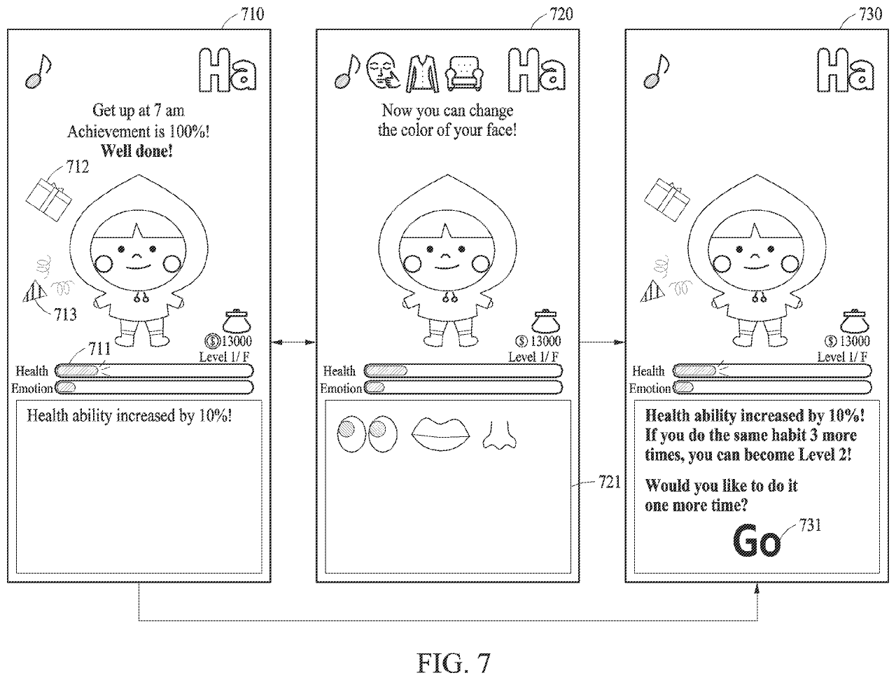

FIG. 7 is a diagram illustrating a result of completing a habit-forming project according to an exemplary embodiment. Referring to FIG. 7, after the habit-forming project is completed, the habit-forming software may display the achievement through a completion interface 710. The habit-forming software may display on the completion interface 710 the ability points 711 of the avatar, which increases according to the achievement rate of the habit-forming project. For example, in the completion interface 710, newly acquired gauges as a result of completing a habit-forming project are displayed in contrast with current gauges such as the avatar's health ability and emotion ability (for example, the acquired gauge is displayed in a different color, or the obtained gauge can be expressed as an animation). In addition, in order to provide a surprise reward that the user may not predict, the habit-forming software may provide an object 712 for a surprise gift or an object 713 for a surprise event on the completion interface 710.

According to one embodiment, the habit-forming software may request verification of the user's improved state in the real world, such as a survey on the user's current health state and/or photo verification of the user's current body shape after the habit-forming project is completed. In this case, after the user's improved state in the real world is verified, the aforementioned acquisition gauge may be reflected as the avatar's ability point(s), and in some cases, the acquisition gauge may be adjusted (increased or decreased) according to the verification result of the user's improved state and reflected as the avatar's ability point(s).

An avatar's ability point(s) corresponding to the habit category of the habit-forming project may increase, and the type or number of selectable or controllable items may increase according to the increased ability point(s). The increase in the ability point(s) may be determined by considering the difficulty of the habit-forming project as well as the achievement rate of the habit-forming project.

The habit-forming software may display an avatar editing interface 720 for modifying an avatar according to an increased ability values corresponding to the habit category. Since the contents of the avatar modification interface 320 described above through FIG. 3 can be applied to the avatar modification interface 720 as it is, a detailed description thereof will be omitted. In the item view 721, selectable items may be displayed according to the increased ability values. According to the habit-forming service, the user can change the fundamental appearance of his or her avatar through an increase in ability level and/or an avatar level as a result of completing a habit-forming project.

The habit-forming software may display in the completion interface 730 information encouraging re-engagement in the same habit-forming project as the completed habit-forming project. For example, when a predetermined condition (e.g., 30 seconds has elapsed) is satisfied in the completion interface 710 or the avatar modification interface 720, the habit-forming software provides information leading to re-participation through the completion interface 730. can be displayed. In this case, the information inducing re-participation may include an advertisement that provides an additional reward upon re-participation.

When the object 731 inducing re-participation is selected, in consideration of the user's intention to re-participate in the same habit-forming project as the completed habit-forming project, the processes of FIG. 4 may be omitted and the processes of FIG. 5 may be displayed immediately.

Although not shown in the figure, the completion interface 730 may display a result screen related to the return of deposited currency or the distribution of additional prize currency. These result screens can also be set to give a sense of ‘achievement’. For example, the habit-forming software may acquire randomly matched results from a database storing future images that may be recalled later due to actions that have completed the habit-forming project, and display them on the result screen. Alternatively, the habit-forming software may display the celebrity's opinions, quotes, or photos on the results screen.

According to one embodiment, the habit-forming software may provide statistics on the cumulative number of participants and may also provide a review writing function. A certain amount of in-game currency is provided to users who write reviews, and additional in-game currency can be provided to users who write quality reviews.

According to an embodiment, a high-quality habit-forming project that can be participated in only when the user's avatar reaches a specific level may be provided. For example, in case of a high-quality habit-forming project where users form habits with celebrities and are given personal contact opportunities, participation opportunities may be provided only to an avatar who has reached a certain level. In addition, excellent users of the habit-forming service may be provided with the right to directly open and lead a habit-forming project.

According to one embodiment, the habit-forming software may provide a function of storing, sending, or transacting a user's unique avatar based on NFT technology.

According to brain cognitive science, which has been theoretically and clinically revealed so far, humans basically pursue ‘positive emotions’ that can be obtained through actions rather than pursuing ‘duty’. Therefore, users need to provide awareness that habit-forming pays off to them in the long run. To this end, the habit-forming service may be serviced by evenly considering the fun factor, the scientific factor, and the interaction(communication) factor as shown in Table 4.

TABLE 4

| | |
|---|---|
| Fun | Achieve personal goals −> visualize avatar growth |
| Science | 1. Organic composition based on brain neuroscience: A strategy to increase |
| | the sense of achievement by making habit-forming accessible from the |
| | challenge level with low difficulty by level |
| | *For flexibility, it is designed to allow access to the next project by paying a |
| | certain amount of in-game currency. |
| | *If users gather a growth group (more than 5 people), users can open a |
| | project for each group |
| | 2. Personalized marketing: Since the timing of habit-forming is different for |
| | each individual, even after achievement is achieved, users are encouraged to |
| | maintain the habit by inducing re-participation through authentication |
| Interaction | 1. Principles of habit-forming with other user from the beginning of project |
| (communication) | participation or changes when this habit becomes action Watching short |
| | video clips, audio communication |
| | 2. It is possible to communicate and communicate with each other through |
| | SNS (mobile phone object in the app) in the app even during habit-forming |
| | authentication |
| | 3. After completing the project, users can add them as friends and participate |
| | in other projects together. |
| | 4. Random chatting is possible while looking at the appearance of the avatar |
| | while walking around the village in the game. |

Modern people live a life in which their lifestyle is reflected in their appearance and health. The habit-forming service can provide a user experience in which a real person forms a habit and develops his or her own avatar through self-development activities, and physically and emotionally nurtures himself through participation in a virtual space.

According to the habit-forming service according to the embodiments, since users change the habits of real users in a healthy way, nurture avatars, and interact with others with similar interests, they can use the platform to make their time more efficient and life-saving.

The habit-forming service according to embodiments introduces a game element to provide effective matching that appears in a village within the service, for example, a function of randomly interacting with avatars having similar or different interests to oneself.

FIG. 8 is a block diagram illustrating a configuration of a terminal for operating habit-forming software according to an exemplary embodiment. Referring to FIG. 8, a terminal 800 according to an embodiment may include a processor 810, a display 820, a communication interface 830, and a memory 840. The processor 810, display 820, communication interface 830, and memory 840 may be connected to each other through a communication bus 805.

The processor 810 may perform at least one operation or function described above with reference to FIGS. 1 to 7. The processor 810 may execute a program and control the terminal 800. Program codes executed by the processor 810 may be stored in the memory 840.

The memory 840 may store various pieces of information generated in the process of the processor 810 described above. In addition, the memory 840 may store various data and programs. The memory 840 may include a non-volatile storage medium such as an SSD or a flash memory to store various types of data.

The above-described exemplary embodiments may be implemented as a processing device by a hardware component, a software component, and/or a combination of a hardware component and a software component. For example, the apparatus, method, and components described in the exemplary embodiments may be implemented by using one or more general purpose computers or special purpose computers, for example, like a processor, controller, arithmetic logic unit (ALU), digital signal processor, microcomputer, field programmable gate array (FPGA), programmable logic unit (PLU), microprocessor, or any other device capable of executing and responding to instructions. The processing device may execute an operating system (OS) and one or more software applications executed on the operating system. Further, the processing device may also access, store, manipulate, process, and generate data in response to execution of the software. For convenience of understanding, in some cases, one processing device is described as being used, but it will be apparent to those skilled in the art that the processing device includes a plurality of processing elements and/or a plurality of types of processing elements. For example, the processing device may include a plurality of processors or one processor and one controller. Other processing configurations are also possible, such as parallel processors.

Software may include a computer program, code, instructions, or one or more combinations thereof, for independently or collectively instructing or configuring the processing device to operate as desired. Software and/or data may be permanently or temporarily embodied in any type of machine, component, physical or virtual equipment, computer storage medium or device, or in a propagated signal wave in order to be interpreted by the processing device or provide instructions or data to the processing device. Software may be distributed over network coupled computer systems so that the software is stored and executed in a distributed manner. Software and data may be stored in one or more computer-readable recording media.

The methods in accordance with exemplary embodiments may be implemented in the form of program instructions that may be executed by various computer means and recorded in a computer-readable medium. The computer-readable medium may include program instructions, a data file, a data structure, or the like alone or in combination. The program instructions recorded on the medium may be specially designed and configured for the exemplary embodiments, or may be known and available to those skilled in the art of computer software. Examples of the computer-readable recording medium include magnetic media such as hard disks, floppy disks, and magnetic tapes, optical media such as CD-ROMs and DVDs, magneto-optical media such as floptical disks, a hardware device specially configured to store and execute program instructions, such as ROM, RAM, flash memory, or the like. Examples of the program instruction includes not only machine language codes such as those produced by a compiler, but also high-level language codes that can be executed by a computer using an interpreter or the like. The hardware device may be configured to operate as one or more software modules to perform operations of exemplary embodiments, and vice versa.

Although the exemplary embodiments have been described with reference to the limited drawings as described above, those skilled in the art may apply various technical modifications and variations based on the above. For example, even if the described techniques are performed in an order different from the described method, and/or the components of the described system, structure, apparatus, circuit, or the like are coupled or combined in a different form from the described manner, or supplemented or substituted by other components or equivalents, suitable results may be achieved.

What is claimed is:

1. A method for operating a habit-forming software, the method comprising:
displaying a village interface including a plurality of places corresponding to a plurality of habit categories;
receiving an input of a user requesting participation in a habit-forming project belonging to any one habit category selected through the village interface from among the plurality of habit categories;
displaying a meeting interface including an avatar of the user and avatars of other users participating in the habit-forming project;
while the habit-forming project is in progress, activating an authentication button for performing an authentication action specified in the habit-forming project at a time specified in the habit-forming project;
receiving an input of the user performing the authentication action through the authentication button; and
displaying the avatar of the user that visually expresses at least one of a plurality of ability points, wherein an ability point, from among the plurality of ability points, corresponding to the habit category is increased based on an achievement rate of the habit-forming project according to the authentication action.

2. The method of claim 1, wherein the displaying of the avatar of the user comprises:
providing usable items according to the ability point corresponding to the habit category, wherein as the ability point increases, more various items are provided; and
applying an item, from among the items, selected by the user to the avatar of the user.

3. The method of claim 2, wherein the usable items comprise at least one of:
a first type of item that transforms an appearance of the avatar itself; and
a second type of item worn on the avatar.

4. The method of claim 2, wherein an additional user authentication is required when the selected item is an item of a specific level or higher, and the selected item is applied to the avatar of the user when the additional user authentication succeeds.

5. The method of claim 1, wherein a type and/or a number of habit-forming projects that the user can challenge increases based on at least one of a level of the avatar and levels of the plurality of ability points.

6. The method of claim 1, further comprising:
displaying an authentication photo of another user participating in the habit-forming project; and
receiving an input of the user for inspecting an authentication action of the other user,
wherein achievement rates of the users are determined according to results of the users participating in the habit-forming project inspecting each other's authentication action.

7. The method of claim 1, further comprising:
displaying information that induces participation in the same habit-forming project after a predetermined period of time after the habit-forming project completes,
wherein in-game currency for participating in the participation-induced habit-forming project are discounted or exempted, and rewards are paid when the participation-induced habit-forming project is achieved to a predetermined level or higher.

8. The method of claim 1, wherein the plurality of ability points include at least one of a health ability, an emotion ability, a relationship ability, a career ability, and a finance ability,
and the plurality of habit categories include at least one of the first category corresponding to the health ability, the second category corresponding to the emotion ability, the third category corresponding to the relationship ability, the fourth category corresponding to the career ability, and the fifth category corresponding to the finance ability.

9. The method of claim 2, wherein the usable items comprise at least one of:
a third type of item that imparts a skill to the avatar; and
a fourth type of item that imparts an emotional expression function to the avatar.

10. The method of claim 6, wherein when an input of the user indicating that the authentication action of the other user is disqualified is received, a final inspection result of the authentication action of the other user is determined through additional inspection by other users participating in the habit-forming project.

11. The method of claim 1, further comprising:
activating buttons for sending friend requests to the avatars of the other users through the meeting interface when the habit-forming project completes.

12. The method of claim 1, further comprising:
displaying an interface for modifying the avatar according to an increased ability point corresponding to the habit category when the habit-forming project completes; and
displaying information for inducing re-participation in the same habit-forming project as the completed habit-forming project.

13. The method of claim 1, further comprising at least one of:
when an input of the user participating with an avatar of a friend user is received through the village interface or a place interface displaying detailed habit items or challenge steps corresponding to a place included in the village interface, displaying the detailed habit items or the challenge steps determined in consideration of the ability point of the avatar of the user and an ability point of the avatar of the friend user in a selectable form; and
when an input of the user participating with the avatar of the friend user is received through the meeting interface, displaying a friend list determined in consideration of the detailed habit items and the challenge steps of the habit-forming project in a selectable form.

14. The method of claim 1, further comprising:
conducting a survey on at least one of the plurality of habit categories to the user; and
recommending at least one habit-forming project determined based on a result of the survey to the user.

15. A computer-readable recording medium that has a program for executing the method of claim 1.
